(19) United States
(12) Patent Application Publication
(10) Pub. No.: US 2026/0118288 A1
(43) Pub. Date: Apr. 30, 2026

(54) Holding device for a disc-shaped component for X-ray inspection and method for clamping the component to a holding device

(71) Applicant: Comet Yxlon GmbH, Hamburg (DE)

(72) Inventors: Delf Reumann, Hamburg (DE); Andreas Wagner, Hamburg (DE); Tim Bouwens, Veldhoven (NL); Daan Timmers, Veldhoven (NL); Leo Sanders, Veldhoven (NL)

(21) Appl. No.: 19/364,333

(22) Filed: Oct. 21, 2025

(30) Foreign Application Priority Data
Oct. 25, 2024 (DE) 10 2024 131 154.1

(51) Int. Cl. G01N 23/083; G01N 23/044; G01N 23/18

(52) U.S. Cl. CPC G01N 23/083; G01N 23/044; G01N 23/18; G01N 2223/321; G01N 2223/6116

(57) ABSTRACT

A holding device for a disc-shaped component, in particular for a wafer, as part of a manipulator of an X-ray inspection system is disclosed. The holding device includes an X-ray tube and a detector in which the position and orientation of the component can be corrected by radial clamps. The radial clamps exert a force in the direction of the center of the component in the plane thereof. Access to the component is enabled for the X-ray tube on one side of the component and allows for a free space on the other side of the component for the beam cone of the X-ray tube.

### PRIORITY CLAIM

The present application claims priority under 35 U.S. C. § 119 to German Patent Application No. DE 10 2024 131 154.1, filed Oct. 25, 2024, the disclosure of which is incorporated by reference herein in its entirety.

### TECHNICAL FIELD

The present disclosure relates to a holding device for a disc-shaped component, in particular a wafer, as part of a manipulator of an X-ray inspection system. The present disclosure also relates to a method for clamping the component in its edge region to a holding device. For the sake of simplicity, the term “wafer” is generally used in the following to refer to all possible disc-shaped components without this being understood as limiting; however, the term “component” is used to make it clear from their content that the patent encompasses all disc-shaped components.

### BACKGROUND

During the inspection of a wafer on which the test objects are mounted using high-resolution computed laminography with an X-ray inspection system, the X-ray tube must be moved very close to the wafer in order to achieve the highest possible magnification of the test object. Due to the spatial extent of the X-ray tube, the corresponding region (above or below the wafer) must therefore be accessible, even beyond the lateral edge of the wafer. Furthermore, the X-ray beam must be able to penetrate the wafer unhindered so that the image of the test objects is not overlaid by interference caused by the wafer holder. This means that no material other than the wafer (along the X-ray beam) should obstruct the X-ray beam between the detector and the X-ray tube. Furthermore, the wafer must be moved by the holding device to which it is fixed for inspection along a corresponding trajectory through the X-ray beam. There must be no play between the holding device and the wafer that would allow a relative movement that would alter the trajectory. The holding device is part of a manipulator, which is usually movable in the X and Y directions in the plane of the manipulator.

Most wafer holding devices ignore the needs of X-ray technology and computed laminography. Common solutions either work with vacuum technology over a large area from the underside, which inevitably means that the vacuum technology underneath the wafer must also be irradiated. Their contrast is very high compared to the structures on the wafer to be inspected, with the consequence that defects or structures in the test objects are obscured. Alternatively, there are ring mounts, in which case the ring has a significant width and its depth also severely limits the magnification due to the required distance of the X-ray tube to the wafer. In addition, there are wafer holding devices in which the holding device is clamped over the outer diameter. In most cases, the mechanism or the jaws themselves block the irradiation of the wafer when the detector is tilted by up to 60° (such holding devices are described, for example, in CN 114603527 B and CN 117542790 A). If the holding device is positioned on the side facing away from the tube, the laminography angle results in shading, which reduces the usable inspection area to the center of the wafer.

### SUMMARY

It is therefore an object of the present disclosure to provide a holding device for a disc-shaped component by which, when the component is being inspected in an X-ray inspection system, its edge region can also be inspected without interference due to the supporting of the component, as well as a method for clamping the component in its edge region.

This object may be achieved according to the present disclosure by a holding device for a wafer as part of a manipulator of an X-ray inspection system. The object may also be achieved by a method. Advantageous embodiments are also specified.

According to the disclosed embodiments, the object is achieved by a holding device for a wafer as part of a manipulator of an X-ray inspection system that includes an X-ray tube and a detector in which the position and orientation of the component can be corrected by radial clamps, each of which exerts a force in the direction of the center of the component in the plane thereof, and in which access to the component is enabled for the X-ray tube on one side of the component and which allows for free space on the other side of the component for the beam cone of the X-ray tube.

The object is also achieved by a holding device for a wafer as part of a manipulator of an X-ray inspection system that has a support surface formed in a plane that extends at least partially along a circular ring with a stop edge extending at least partially along a cylinder lateral surface, which stop edge extends perpendicular to the support surface and has a diameter that is slightly larger than the diameter of the wafer to be received. This enables the wafer to be easily attached to the holding device by placing it on the support surface. The holding device also has a base body that extends outside the cylinder surface and on which the support surface is located. This ensures that there is enough space on the support surface upon placement of the wafer. The holding device also has at least three radial clamps, each of which is linearly movable between an open position and a locked position by a first displacement device, each of which is linearly movable in the radial direction relative to the support surface by a radial control element. This enables the wafer to be positioned very precisely in the holding device, which is necessary for good reconstruction during the X-ray laminography process. The holding device also has at least two axial clamps, each of which is movable between an open position and a clamping position by a second displacement device, each of which is movable by an axial control element, the movement of the axial clamps taking place both in the radial and axial direction with respect to the support surface. This enables very precise positioning of the wafer on the holding device while minimizing relative movement of the wafer with respect to the holding device while the manipulator is being moved. Advantages are achieved in both X-ray inspection and in 3D X-ray processes. These include the ability to inspect peripheral regions, high magnification, and oblique radiography at large angles. The latter makes it possible to distinguish between different layers in the object being inspected. A holding device according to the present disclosure ensures very good reconstruction within the framework of an X-ray laminography process. The fact that the support surface, the radial clamps, and the axial clamps are securely connected to the base body ensures the fixed positioning of the wafer on the holding device. The holding device also has a cam ring that has a control contour that is always in contact with the radial control elements and the axial control elements. This allows for movement of the radial and axial clamps that is easy-to-implement and also functions very precisely. The holding device also has a connecting device for connecting the holding device to the manipulator.

An advantageous refinement of the disclosed embodiments makes a provision that the support surface extends at least partially along a circular ring with a stop edge extending at least partially along a cylinder lateral surface, which stop edge extends perpendicular to the support surface and has a diameter that is slightly larger than the diameter of the wafer to be received, and the base body extends outside the cylinder lateral surface. This enables the wafer to be easily inserted into the holding device and pre-centered, and the base body and the support surface are not in the beam path during the X-ray inspection.

Another advantageous refinement of the disclosed embodiments makes a provision that the support surface is formed from individual surfaces that are formed on U-shaped clips in the region of the connecting bar of the U and the free ends of the parallel bars of the U are securely connected to the base body. This saves a huge amount of material compared to a comprehensive formation of the support surface and, at the same time, achieves entirely sufficient fixation of the wafer to the holding device, so that no displacement of the wafer relative to the holding device can occur during passage along the trajectory during the inspection, which would result in an adulteration of the inspection result. The U-shape of the clips saves even more material than if they were made solid. V-shaped clips can also be used instead of U-shaped clips, in which case the support surface is formed in the region where the two bars of the V meet, and the free ends of the two bars of the V are securely connected to the base body.

Another advantageous refinement of the disclosed embodiments makes a provision that the axial clamps each have a support element on which a support surface is formed, and each has a clamping element, which clamping elements are movable independently of one another, the clamping elements being radially movable, and the support elements being movable in a direction with an axial component, in particular about a horizontal axis of rotation. This makes insertion easier, particularly in designs in which the X-ray tube is arranged above the holding device and there is therefore little space for inserting the wafer into the holding device, since the support surface can be lowered during insertion and is moved upward only afterward. This also offers the advantage that even a warped wafer does not protrude too far in the direction of the X-ray tube, since it lies lower in the holding device, and the highest points of the edge of the wafer in the direction of the side facing the tube are limited by the axial clamps, since these—if they have springs—give way with their springs toward the side facing away from the tube.

Another advantageous refinement of the disclosed embodiments makes a provision that the axial control element of the axial clamp cooperates with the support element, and the second displacement device additionally has a further axial control element that cooperates with the clamping element. This means that there is no need to install a complicated mechanism in the second displacement device that controls the movement of the two individual parts together, but rather the movement of each of the two individual parts—support element and clamping element—is controlled separately by an axial control element, it being possible for a simple mechanism to be used for each.

Another advantageous refinement of the disclosed embodiments makes a provision that the radial clamps and/or the axial clamps are arranged in the free space of the clips between the two parallel bars of the U. This makes the device more compact, and the clamps are also better protected against mechanical damage since they are arranged between the legs of the clips.

Another advantageous refinement of the disclosed embodiments makes a provision that exactly three radial clamps are present, of which exactly one has a nose at its free end that has the shape of a part of a cylinder surface perpendicular to the support surface. Through the use of exactly three radial clips, the wafer can be positioned on the holding device exactly in the position with which the trajectory is aligned during the subsequent wafer inspection without redundancy. The nose of one radial clamp, which is embodied as a rounded free end, allows for precise angular alignment with respect to the center axis of the wafer when the nose is inserted into the notch on the edge of the wafer, which wafers normally have.

Another advantageous refinement of the disclosed embodiments makes a provision that all free ends of the radial clamps and/or of the axial clamps have a plastic end part that is detachably connected to the rest of the respective clamp. The use of a plastic, especially if it is soft enough, ensures that no damage occurs to the wafer while it is positioned against and secured to the holding device. Because the ends can be detached from the rest of the clamps, if the (preferably soft) plastic ends become worn, they can be easily replaced without having to replace the entire affected clamp. Soft non-ferrous metal, rubber, silicone, or silicone rubber can also be used as an alternative to plastic.

Another advantageous refinement of the disclosed embodiments makes a provision that there are exactly six axial clamps associated in pairs, and the distances between adjacent pairs are equal and/or a radial clamp is arranged between the two axial clamps of a pair. The equidistant arrangement of the pairs ensures good support of the wafer on the support surface. Through the arrangement of a radial clamp between each of the two axial clamps of a pair - in the event that the pairs are arranged equidistantly from each other - a star-shaped arrangement of the fixing points at 120° in the radial direction is achieved, which results in reliable positioning of the wafer in the plane thereof. This makes it easier to clamp a warped wafer (which means that the wafer does not extend exactly in one plane) on the holding device. The spatial proximity of the axial clamps to the radial clip arranged between them ensures that warped wafers, which are saddle-shaped or have the shape of a Pringle, can be gripped with their outer surface by the radial clips.

Another advantageous refinement of the disclosed embodiments makes a provision that the control contours are the same for each radial clamp and the control contours are the same for each axial clamp. This ensures synchronous movement of the respective clamp type. Alternatively, the clamps can also be controlled asynchronously without any adjustments to their design. For example, with differently designed radial clamps, if one of them has a nose for plunging into a notch in the wafer—which leads to an even more precise positioning of the wafer on the holding device—this radial clamp equipped with the nose can be pulled out of the notch immediately before the axial clamping takes place using the axial clamps. This reduces material wear on the nose.

Another advantageous refinement of the disclosed embodiments makes a provision that the second displacement devices of the axial clamps are each embodied as a slider-crank mechanism or as a control link. This makes it possible for the axial clamps to move in a radial direction during the first part of their movement from their open position and in an axial direction during the second part of their movement toward their clamping position, which initially provides more space for inserting the wafer into the holding device and ultimately ensures that the wafer is securely clamped to the holding device without any risk of damaging the wafer.

Another advantageous refinement of the disclosed embodiments makes a provision that the axial clamps are each pressed into their clamping position by a replaceable spring and/or the radial clamps are each pressed into their locked position by a replaceable spring. This enables the contact pressure of the axial clamp in its clamping position or of the radial clamp in its locked position to be varied depending on the type of wafer to be inspected, and if the spring wears out, it can be easily replaced. In addition, this prevents warped wafers and wafers that are not ideally round (i.e., where diameter and roundness tolerances exist) from being subjected to excessive force by the clamps, which could damage the wafers, or from being subjected to insufficient force, which would result in the wafers not being fixed to the holding device during the inspection, which would lead to imaging errors. Spring-loaded axial clamps also have the advantage that the wafer is able to deflect in the axial direction in the event of accidental contact by the X-ray tube and is therefore not damaged or destroyed.

Another advantageous refinement of the disclosed embodiments makes a provision that at least one load compensator is arranged on the base body, which load compensator has a compensator control element that is always in contact with the control contour of the cam ring, the control contour being shaped in the vicinity of the compensator control element inversely to the control contour in the region of the radial control elements and of the axial control elements with respect to its radial distance from the stop edge of the support surface. This makes it possible to reduce the high spring load on the axial clamps and the radial clamps that results from the addition of the spring force applied to each clamp. This prevents jerky movements during operation—especially during large load peaks—and thus prevents damage to the wafer. This also allows for more sensitive operation.

Another advantageous refinement of the disclosed embodiments makes a provision that a first stop and a second stop are formed so as to be stationary on the base body, and a control lever is formed so as to be stationary on the cam ring, the control lever being movable between the first stop and the second stop. This makes it easy to find the end positions of the cam ring when rotating it manually or by motor in order to clamp or release the wafer. The stops serve the purpose, on the one hand, of ensuring that the cam ring can be easily operated and released, and, on the other hand, of providing a simple visualization of whether the clamps are in their respective extreme positions (open and locked position for radial clamps and open and clamping position for axial clamps) and are correctly engaged there.

Another advantageous refinement of the disclosed embodiments makes a provision that the first stop and the second stop are physical devices. They are particularly preferred for manual movement because they are very simple and inexpensive to implement. When the cam ring is moved by a motor, it is advantageous to perform an additional check to see whether the cam ring is actually in one of its stop positions and thus whether the clamps are either in the position in which the wafer is correctly fixed or in the position in which the wafer can be easily removed from or inserted into the holding device. For this purpose, inductive proximity sensors are provided that are arranged in such a way that they can detect whether the cam ring is in one of its stop positions.

Another advantageous refinement of the disclosed embodiments makes a provision that a cam ring drive attached to the manipulator can be connected via a drive lever to a control lever on the cam ring in order to rotate the cam ring relative to the base body and, in particular, to move the cam ring between the two stops. This means that no operator has to go into the radiation booth where the X-ray inspection system is located due to radiation protection regulations, and clamping can therefore be done more quickly. In addition, the holding device according to the disclosed embodiments is also suitable for a fully automatic loading system for unattended continuous operation.

Another advantageous refinement of the disclosed embodiments makes a provision that the combination of clips and base body is designed such that no part is located outside an angular range of more than 20° in the radial direction with respect to the component, which ranges from the plane of the underside of the clips, which extends parallel to the plane of the component, around the apex, which is located at the intersection point of the central beam of the X-ray tube used for inspection in its radially outermost point during inspection with said plane. This means that, in an X-ray laminography process, the entire wafer, with the exception of the edge region where the clamping takes place on the holding device, can be inspected without any disruptive parts in the beam cone, even at laminography angles of up to 60° and an X-ray beam aperture angle of 20°. If an even larger laminography angle is to be used during inspection, the angular range of the combination of clips and base body must be even smaller as an alternative; for example, with a laminography angle of 65° and an X-ray beam aperture angle of 20°, the angular range must be 15°. For smaller laminography angles, larger angular ranges are also possible as an alternative design, in which case the angular range must be 90°—laminography angle—half the opening angle of the X-ray beam, meaning an angular range of 25°, for example, with a laminography angle of 55° and an opening angle of the X-ray beam of 20°, an angular range of 30° with a laminography angle of 50° and an opening angle of the X-ray beam of 20°, and so on.

The object is also achieved by a method according to the disclosed embodiments for clamping a wafer to a holding device as part of a manipulator of an X-ray inspection system. The component is placed in a pre-aligned manner on a support surface, after which a radial alignment and an angular alignment of the component are carried out by radial clamps and a fixing of the component in the axial direction is carried out by axial clamps. This enables the wafer to be precisely aligned, and it remains securely in position on the holding device even if the holding device moves during the X-ray inspection of the wafer, so that no inaccuracies occur during the inspection. This enables the wafer to be precisely aligned on the holding device and securely clamped to the holding device as the holding device moves during inspection, preventing inaccuracies in data acquisition.

An advantageous refinement of the disclosed embodiments makes a provision that the movement of the axial clamps takes place first in the radial direction and then in the axial direction. This enables the axial clamp to be in a radially retracted position during the insertion of the wafer into the holding device, resulting in more clearance during insertion.

An advantageous refinement of the disclosed embodiments makes a provision that first a radial movement of the clamping element and then a movement of the support element of the axial clamps with an axial component takes place, in particular through a rotation about the axis of rotation, until the component is fixed in the axial direction between the clamping element and the support element. This enables more space to be made available in the axial direction during the insertion of the wafer into the holding device, which is particularly important for designs in which the X-ray tube is arranged above the wafer. When the wafer is secured between the support element and the clamping element, the wafer is then moved upward so that the X-ray tube can be moved very close to it in order to achieve the greatest possible magnification.

Another advantageous refinement of the disclosed embodiments makes a provision that the radial movement of the axial clamps takes place simultaneously with the radial alignment of the component. This reduces the overall time required for wafer insertion, positioning, and clamping, as the axial clamps move during wafer positioning.

Another advantageous refinement of the disclosed embodiments makes a provision that, in the axial clamps and/or the radial clamps, the maximum force acting on the wafer is limited by a spring force. The spring force limitation of the axial clamps prevents the axial pressure on the edge of the wafer from becoming too great during clamping and causing damage to the wafer. The spring pressure must be great enough to hold the wafer securely in place on the holding device and limited enough that it cannot bend the edge of the wafer. This is particularly necessary in the case of warped wafers whose shape deviates from the ideal flat shape in one plane. The same applies to the spring force limitation of the radial clamps and their pressure in the axial direction on the edge of the wafer.

Preferably, the method is carried out by a holding device according to the disclosed embodiments.

### BRIEF DESCRIPTION OF THE FIGURES

Further details and advantages of the disclosed embodiments will now be explained in greater detail with reference to an exemplary embodiment that is illustrated in the drawings, in which:

FIG. 1 shows an isometric view of a holding device according to some embodiments.

FIGS. 1A and 1B show two enlarged sections of FIG. 1 from a slightly different viewing direction.

FIG. 2 shows a schematic plan view of the holding device of FIG. 1.

FIG. 3 shows a view similar to FIG. 2 but from below and with details of a manually movable cam ring together with the radial and axial clamps interacting therewith.

FIG. 4 shows an enlarged section of FIG. 3 in a motor-operated embodiment.

FIG. 5 is an isometric view of an enlarged section of a further embodiment in the region of a group of radial and axial clamps in which the X-ray tube is arranged above the wafer.

FIG. 6 shows a schematic longitudinal section through the base body including wafer, X-ray tube, and axial clamps.

FIG. 7A shows a reduced section of FIG. 6 with additional detector.

FIG. 7B shows an enlargement of a region of FIG. 6.

FIGS. 8A-D show a schematic representation of the operating principle of an axial clamp in four phases.

FIGS. 9A-C show a schematic representation of the operating principle of a radial and an axial clamp in three phases in an X-ray inspection system in which the X-ray tube is arranged above the wafer.

### DETAILED DESCRIPTION

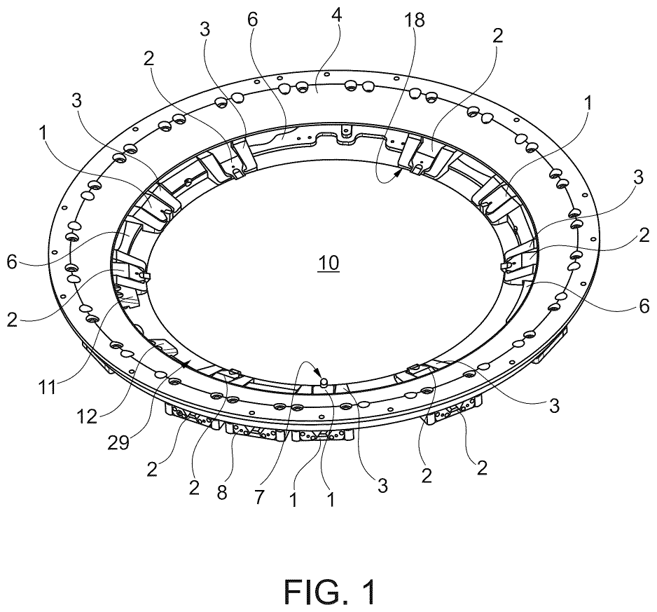

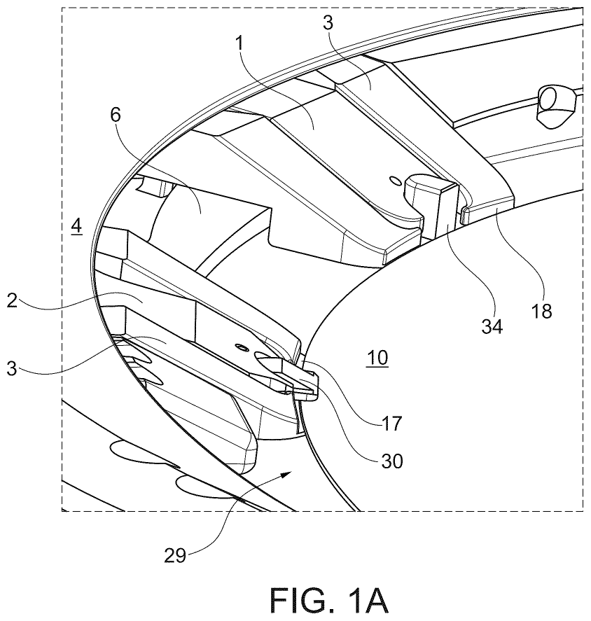

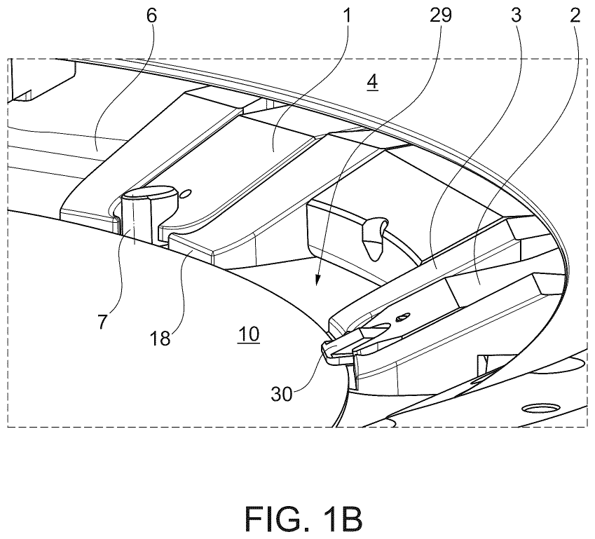

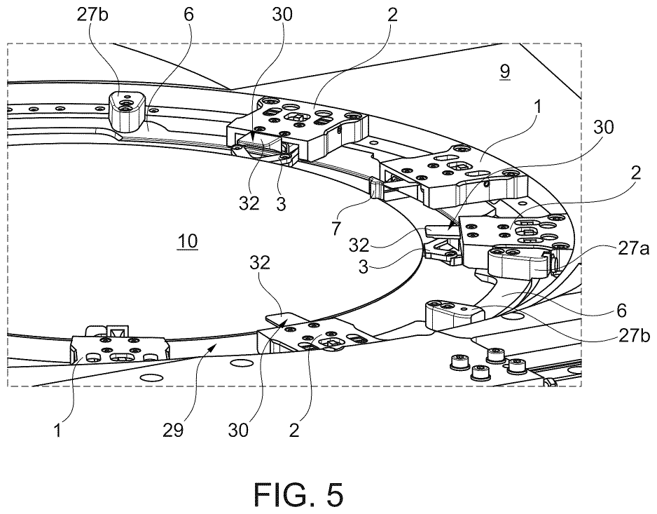

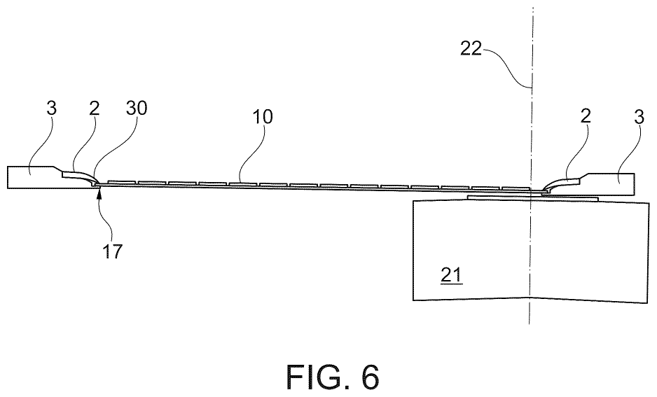

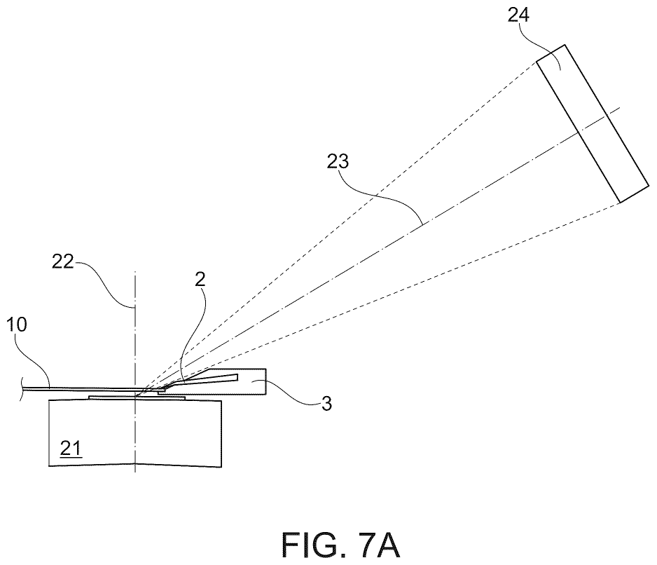

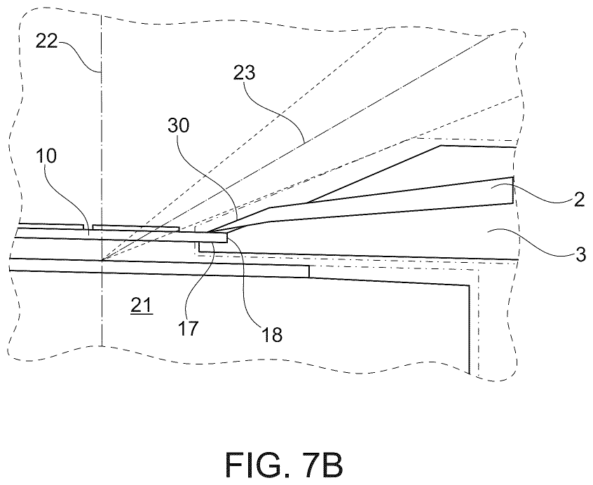

FIG. 1 shows a holding device according to some embodiments for an X-ray inspection system for inspecting wafers 10 that can be installed in a manipulator 9 (not shown; see FIG. 5) in the form of a table that can be moved in the XY plane (horizontally). The vertical rotation axis belonging to the manipulator 9 is aligned such that it is collinear with the central axis of the wafer 10 to be inspected. The holding device according to the disclosed embodiments is thus installed or integrated collinearly into the kinematically last object axis (in the direction of the stationary structure). The other components of the system - for example the X-ray tube 21 (see FIG. 6-8) and the detector (see FIG. 7) - are not shown, since they are not part of the disclosed embodiments.

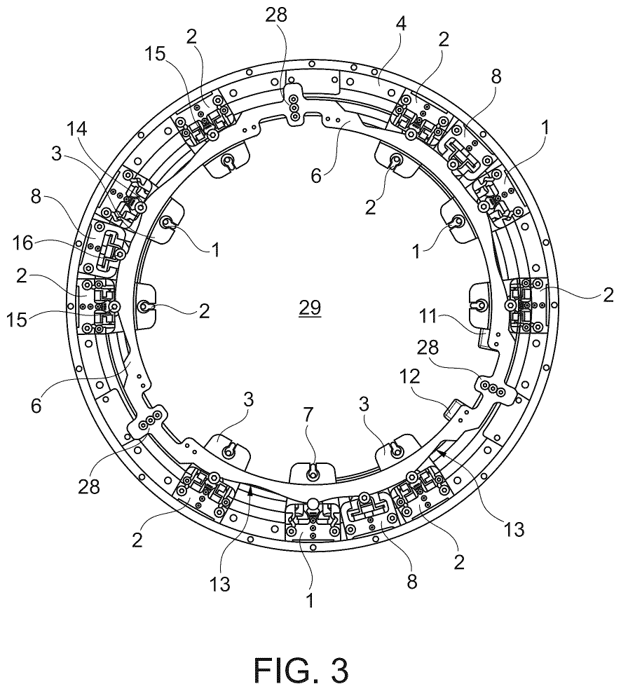

The holding device has a base body 4 that can rotate relative to the manipulator 9. Nine U-shaped clips 3 protrude into an open interior space, which serves as a receiving opening 29 (see also FIGS. 1A and 1B) for the wafer 10 to be inspected. On these, support (partial) surfaces 17 (see FIGS. 3, 4 and 6-8) are formed in the region of the connecting bar of the U. The support (partial) surfaces 17 are limited by vertically extending stop edges 18 (see also FIGS. 1A and 1B). The free ends of the two parallel bars of the clips 3 are securely connected to the base body 4. The wafer 10 clamped in the holding device rests on the support surface 17, which is formed from the partial surfaces on the clips 3.

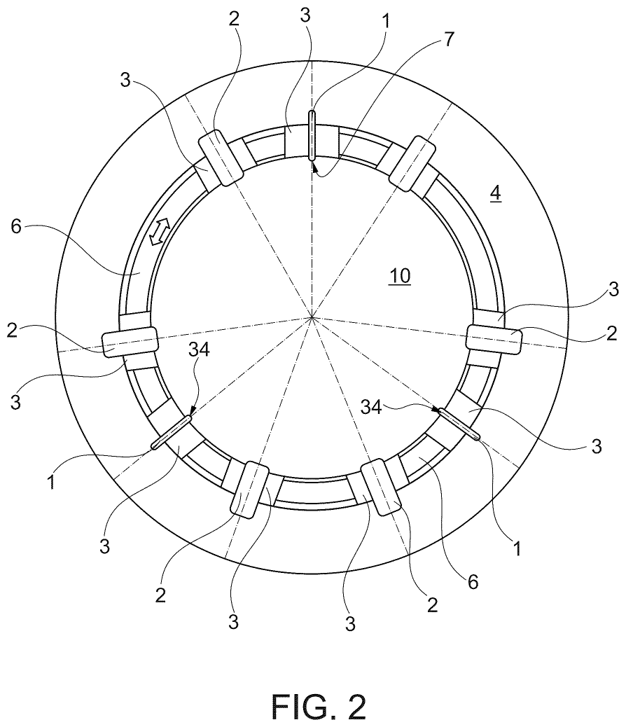

The wafer 10 was centered in the XY plane (horizontal plane) before being clamped by three radial clamps 1 and fixed by six axial clamps 2 to the clips 3 of the holding device. A radial clamp 1 is arranged between two axial clamps 2, which are spaced equidistantly from the radial clamp 1. The radial clamps 1 are arranged in such a way that there is an angle of 120° between them in relation to the center of the wafer 10 (see FIG. 2). The six axial clamps 2 have identical constructions; however, the radial clamp 1 shown below in FIG. 1 differs from the other two radial clamps 1 in that it has a nose 7 (for the nose 7, see in particular the explanations referring to FIGS. 1B and 2). For the three clamps 1, 2 shown below in FIG. 1, their respective mechanics can also be seen from behind (below the base body 4). A load compensator 8 can also be seen between the mechanisms of the left axial clamp 2 and the radial clamp 1 in the lower part of FIG. 1 (more details about this can be found in the description referring to FIG. 3).

Two mechanical stops—a first stop 11 and a second stop 12—are also arranged on the cam ring 6 that serve to ensure that the cam ring 6, which is rotatably arranged on the base body 4 and controls the movement of the radial clamps 1 and the axial clamps 2, is able to be moved manually between two stop positions.

FIG. 1A shows an enlarged section of the left area of FIG. 1 under a flatter viewing angle.

An axial clamp 2 can be seen on the left that is located between the two legs of a clip 3, the front end of the axial clamp 2 being embodied as a clamping body 30 that presses the wafer 10 downward onto the support surface 17 and clamps it in this position.

Visible above that on the right is a radial clamp 1, which is also located between the two legs of a clip 3. At its free end, the radial clamp 1 has a radial positioning surface 34 that presses in the radial direction onto the edge of the wafer 10 and correctly positions it in conjunction with the two other radial clamps 1 (see FIG. 1). The vertically (axially) extending stop edge 18 can be clearly seen on the clip 3, between which and the edge of the wafer 10 a small gap is formed, thus enabling the pre-positioned wafer 10 (in the case of automatic feeding) to be placed with play on the support surface 17 before the final fine positioning is then carried out by the three radial clamps 1. The same applies when manually placing the wafer 10 on the support surface 17

FIG. 1B shows an enlarged section of the upper right region of FIG. 1 under a flatter viewing angle.

An axial clamp 2 (right) and a radial clamp 1 (top) are also shown here. The axial clamp 2 does not differ from the one in FIG. 1A, so it will not be discussed in detail here. However, the radial clip 1 differs from that of FIG. 1A and the other radial clip 1 shown below in FIG. 1 in that it—unlike the other two—does not have a radial positioning surface 34, but rather a nose 7 that dips into a notch in the edge of the wafer 10 and thus ensures even better radial positioning of the wafer 10.

Both the radial positioning surfaces 34 and the nose 7 have a height (in the axial direction) that is approximately 6 mm in the exemplary embodiment. This also allows for secure positioning of warped wafers 10 in which the edge of the wafer 10 is not in a (horizontal) plane.

In FIG. 2, the holding device is shown schematically in plan view; here, the cam ring 6 extends below the radial clamps 1 and the axial clamps 2 together with the respective holders. The rotational movement of the cam ring 6 relative to the base body 4 is indicated by a double arrow.

It can also be seen that there are two different types of radial clamps 1. Two identical radial clamps 1 are located at the bottom in FIG. 2. The upper radial clamp 1, on the other hand, has a nose 7 at its free end that protrudes farther than the free ends of the other two radial clamps 1. This nose 7 dips into a notch in the wafer 10, so that the exact angular position of the wafer 10 is fixed in the holding device and thus in the manipulator 9.

By virtue of the six axial clamps 2, which fix the wafer 10 in a vertical direction (i.e., perpendicular to the drawing plane in FIG. 2) to the holding device, no (unintentional) change in position can occur relative to the manipulator 9 (in any spatial direction). By using six axial clamps 2, excellent fixation can be achieved even with warped wafers 10 that are not exactly in one plane.

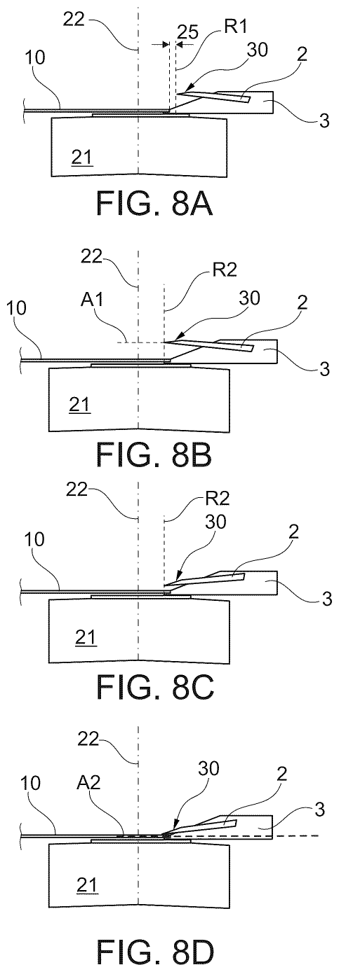

In FIG. 3—in which the wafer 10 has been omitted for better visibility and, in its place, the receiving opening 29 can be seen—the device is shown from below; it can be clearly seen schematically how the cam ring 6 is designed and where it is located in relation to the base body 4 and the clips 3 including radial clamps 1 and axial clamps 2. The cam ring 6 has a control contour 13 that interacts with control elements 14, 15 associated with the clamps 1, 2. In the exemplary embodiment, the control elements 14, 15 are each embodied as rollers; this results in less friction, and less force needs to be applied when rotating the cam ring 6. The radial clamps 1 each have a radial control element 14, and the axial clamps 2 each have an axial control element 15. The control elements 14, 15 are always in contact with the control contour 13 of the cam ring 6, which can be instantiated, for example, by a spring (not shown) as long as the device is open, i.e., the wafer 10 is not clamped in the holding device. If the device is closed, i.e., the wafer 10 is clamped, the control elements 14, 15 can also be spaced apart from the control contour 13. The control elements 14, 15 are in different radial positions depending on the position of the cam ring 6. This radial change in the position of the axial control elements 15 is converted into a radial and an axial movement of the respective axial clamp 2 by a mechanism associated with the respective axial clamp 2. These movements will be explained in greater detail below in connection with FIG. 8A-8D.

As the various radial positions are passed through, the mechanisms associated with the clamps 1, 2 are set in motion.

The mechanism for the radial clamps 1 only has to effect a radial movement of the radial clamp 1 in a horizontal plane, so that the wafer 10, in the clamped state, strikes with its edge the respective free ends of the radial clamps 1 shown at the top of FIG. 3 above and at the bottom of FIG. 2. This can be done using a simple lever mechanism, for example. The radial clamps 1 are spring-loaded, so that tolerances in the edge of the wafer 10 can be compensated for and in order to limit the maximum force that can be exerted by them on the wafer 10. With regard to the radial clamp 1 shown at the bottom of FIG. 3 and at the top of FIG. 2, the nose 7 moves into the notch of the wafer 10 before a final axial fixation by the axial clamps 2 takes place—the angular alignment of the wafer 10 is thus unambiguously achieved (by the radial inward movement of the radial clamps 1, in particular the one with the nose 7, the alignment of the wafer 10 is corrected in position and angular position)—and is then pulled a little ways out of the notch again. The radial clamp 1 is moved from its open position, in which it is as far away as possible from the center of the wafer 10 to be inspected, to its locked position (which is described above). With the holding device according to the disclosed embodiments, the position accuracy can thus be increased compared to the accuracy of the inserting device or manual insertion.

The mechanism for the axial clamps 2 is more complicated, however, since when closing (i.e., clamping), the axial clamp 2 must first perform a radial movement and then a vertical movement in order to come into contact with the edge of the wafer 10. A slider-crank mechanism or link mechanism that is known in principle from the prior art is used for this purpose. The radial movement at the beginning is carried out because it increases the free space when inserting the wafer 10 into the holding device and reduces the risk of a collision with a radial clamp 1, which could result in damage to the wafer. The individual phases of the movement of an axial clamp 2 are shown in FIG. 8 and described in greater detail below.

Three cam ring bearings 28 are formed on the cam ring 6 that extend in the radial direction and are arranged equidistantly from one another and on which guide rollers are arranged that hold the cam ring 6 in a ball bearing arrangement. Alternatively, there may be sliders on the clamps 1, 2 via which the cam ring 6 is guided.

The two stops 11, 12 can be seen on the cam ring 6 at the bottom right. The first stop 11 abuts against the over in the clip 3. If the cam ring 6 is turned to its other stop position (clockwise), it abuts against the right edge of the clip 3 shown at bottom left next to the second stop 12.

In addition, in the exemplary embodiment of FIG. 3, for each group of three clamps 1, 2, there is a load compensator 8 that is controlled by the control contour 13 of the cam ring 6—comparable to the control of the clamps 3—via a compensator control element 16. The load compensators 8 can reduce the high actuating force for the cam ring 6 that results from the addition of the spring force applied to each clamp 1, 2. This allows for more sensitive operation. When operating the holding device, this also prevents jerky movements—especially during large load peaks—which could lead to damage to the wafer 10.

With regard to the materials used that come into contact with the wafer 10, care should be taken to ensure that the wafer 10 is not damaged—in particular, scratched—for which reason they should be softer than the wafer 10. Moreover, the formation of particles due to abrasion should be avoided. Chemically nickel-plated aluminum is preferred because it is wear-resistant and conductive. A corrosion-and wear-resistant layer produced by electrolytic oxidation of aluminum can also be used; however, this layer is not electrically conductive. Alternatively, PEEK can also be considered. However, the materials used must also ensure that when clamped, there is no movement of the wafer 10 relative to the holding device. There should also be no electrostatic charging, so combinations such as aluminum and nickel or PEEK in the conductive ESD (Electrostatic Discharge) variant should be used.

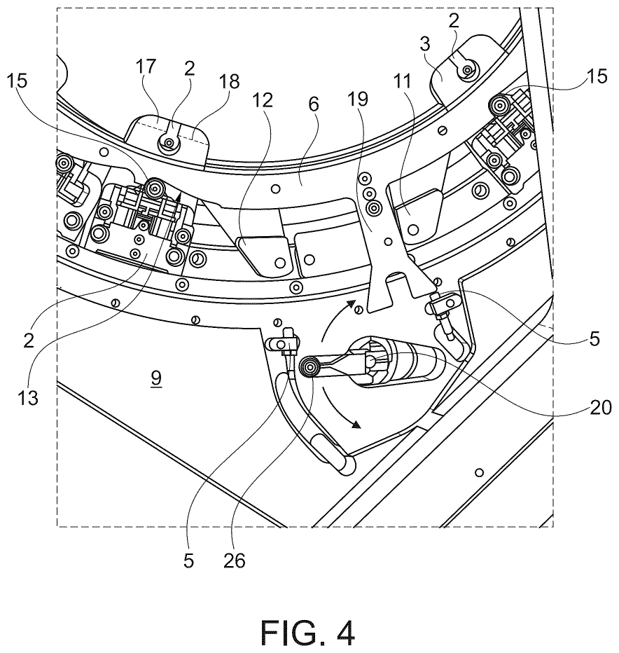

FIG. 4 (the wafer 10 is omitted in this figure as well) shows an enlarged part of a holding device comparable to the exemplary embodiment of FIG. 3 from below. The enlargement makes the interaction of the control elements with the control contour 13 of the cam ring 6 easier to see (only the axial control elements 15 are shown here, since only axial clamps 2 can be seen in the section).

On one of the clips 3 (the one shown farthest to the left), the support surface 17 (which is formed on the side facing away from the viewer) is shown as an example, which is limited in the axial direction toward the outside by a stop edge 18 (shown in dashed lines since it is formed on the side facing away from the viewer so that the wafer 10 can be placed from above on the support surface 17 defined by it). The support surface 17 for the wafer 10 with stop edge 18 is either formed directly on the end of the clips 3 projecting into the opening, or a lip (not shown) is attached beneath the respective clip 3.

A significant difference from FIG. 3 is that a cam ring drive 20 is shown (the shaft thereof is shown, which is fixedly arranged on the manipulator 9, in which the holder device according to the disclosed embodiments is inserted) that rotates the cam ring 6 relative to the base body 4 by a drive lever 26—which can move around the shaft in a circle extending in the plane of the drawing (shown in dashed lines) (the directions of movement are shown by arrows), via a control lever 19 formed on the cam ring 6.

Another difference is that the control lever 19 is fork-shaped at its free end, so that there is a recess between the prongs into which the drive lever 26 can engage during its movement on the circular path indicated by the two arrows. The cam ring 6 is rotated as long as the drive lever 26 engages in the recess on the control lever 19. The control lever 19 strikes a second stop 12 in FIG. 4, and its right prong is situated opposite an inductive proximity sensor 5 in FIG. 4. The cam ring drive 20 is switched off when this position of the control lever 19—coming from the left—is exceeded; the proximity sensor 5 checks the correct execution of the locking function by the control lever 19 at the second stop 12. Then the drive lever 26 is no longer engaged with the recess between the prongs on the control lever 19. In this position, the axial clamps 2 are in their clamping position A2 (see FIG. 8D). On the other hand, the axial clamp 2 is in its open position R1 (see FIG. 8A) when the control lever 19 is at its first stop 11, which is situated opposite another inductive proximity sensor 5.

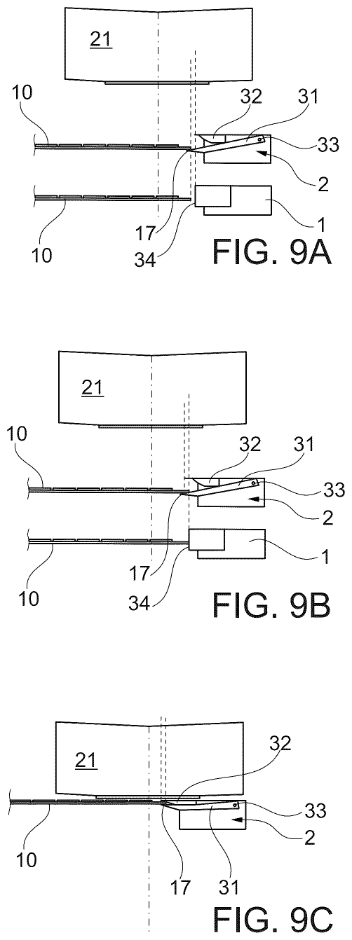

FIG. 5 also shows an enlarged section of a part of a holding device, in a variant in which the X-ray tube 21 (not shown) is arranged above the wafer 10 (see also FIGS. 9A to 9C, in contrast to the representations in FIGS. 6, 7A, 7B and 8A to 8D) in an isometric view in its state as installed in the manipulator 9. In contrast to FIG. 4, here a wafer 10 is inserted and the receiving opening 29 is predominantly covered (comparable to FIGS. 1, 1A and 1B). This is already centered in the radial direction by the radial clamps 1 (the one shown is the one whose nose 7 dips into the notch of the wafer 10) and is correctly aligned in terms of its angular position. The device is shown in its open position. It can be seen that the clamping element 32 of the clamping body 30 for inserting the wafer 10 is in its radially retracted position (see also FIG. 9A).

Three combined bearing stop elements 27a, 27b arranged on the cam ring 6 are shown by which - together with further such bearing stop elements 27a, 27b that are not shown - the cam ring 6 can be rotated on the base body 4 with low friction. The illustrated bearing stop elements 27a, 27b are a first bearing stop element 27a, which serves as an axial bearing, and two second bearing stop elements 27b, which serve as radial bearings. In total, there are six such bearing stop elements 27a, 27b (3 plus 3). In addition to the bearing, the bearing stop elements also fulfill the function of the manual stops 11, 12 according to FIG. 3. The first bearing stop elements 27a correspond to the second stops 12, and the second bearing stop elements 27b correspond to the first stops 11. If no value is placed on reducing friction as much as possible (and thus improving actuation), in a simplified version the cam ring 6 can also be held in the clamps 1, 2 by plain bearings or sliding blocks (both not shown).

The main difference to the previous figures is the design of the clips 3. These are not U-shaped, but V-shaped; also, the region in which the two legs of the V meet is not interrupted, as is the case with the U-shaped clips 3 as shown in FIGS. 3 and 4. The support surface 17 (covered by the wafer 10) is formed at the connecting region of the two legs of the V, and the clamps 1, 2—which, as above, are also spring-mounted in order to give way when pressure is applied to the wafer 10 and thus prevent or limit damage to the wafer 10 (this applies in particular to the axial clamps 2 if the X-ray tube 21 accidentally touches the wafer 10 and tries to move it in the axial direction, since the wafer 10 can then evade the pressure of the X-ray tube 21 in the axial direction)—protrude through the opening formed between the two legs of the V. The axial clamps 2 are in their intermediate position shown in FIG. 8B.

FIG. 6 shows a schematic longitudinal section through the holding device with most of the components omitted, where an X-ray tube 21 is located below the clamped wafer 10 in its edge region. The central beam 22 of the X-ray tube 21 is shown at 0°. Due to its spatial extent, the X-ray tube also extends below the support surface 17. Instead of the integrated support surface 17, this could also be provided by an additional lip attached to the underside of the clip 3; in the preceding embodiments—in particular those of FIGS. 3 and 4—the lip was an intrinsic component of the clips 3, as is illustrated in the figures therein by way of example on each clip 3 by the dashed line (corresponding to the stop edge 18). In addition to the support surface 17, a stop edge 18 is also formed on the intrinsic lip that forms a circle in the radial direction, the diameter of which circle is slightly larger than the diameter of the wafer 10 to be inspected, so that the latter can be inserted into the receptacle formed by the support surface 17 and the stop edge 18 with little play. The axial clamp 2 is in its clamping position A2 shown in FIG. 8D, so that the wafer 10 is fixed to the holding device and cannot be moved unintentionally even during the movement of the manipulator 9 during the inspection. It can clearly be seen that, due to the very low installation height below the plane of the wafer 10, the X-ray tube 21 with its focus can be moved very close to the wafer 10, which results in very good magnification.

In FIG. 7A the right part of FIG. 6 is shown in an enlargement, and in FIG. 7B the area marked in FIG. 7A is shown again in an enlargement. In addition to the central beam 22 at 0°, the central beam 23 at 60° is also shown, which strikes the detector 24 and is approached during X-ray laminography. During inspection of the wafer 10 at this angle of, for example, 60°, the X-ray beam striking the detector 24 must not pass through a material other than that of the wafer 10 to be inspected in order to avoid interference. For this purpose, the clip 3 and the axial clamp 2—the same applies to the radial clamp 1, which is not shown - are designed in such a way that they do not lie in the beam cone shown that strikes the detector 24. For this purpose, the clip 3 tapers at a very flat angle toward the wafer 10, and the axial clamp 2 is arranged very low above the wafer 10. The region of the beam that is therefore not available upward for the holding device is shown in dashed lines. Furthermore, the clip 3 must not extend far downward in the axial direction from the plane of the wafer 10, since the X-ray tube 21 must be brought as far upward as possible (toward the wafer 10) in order to achieve the highest possible magnification. This region that cannot be used for the holding device is shown with a dash and double dot pattern. For the holding device including base body 4, clips 3, and clamps 2 as well as cam ring 6, only a substantially wedge-shaped region is available in the longitudinal section, which is represented by a dash-dotted line. The vertex of the angle is theoretically the point which, in the longitudinal section, forms the intersection point of the central beam 22 of the X-ray tube 21 at 0° with the plane passing through the horizontal end surface of the X-ray tube 21; however, due to tolerances, this plane lies parallel to and slightly above the plane described. The lower leg extends in the described plane, and the upper leg extends directly below the lower marginal beam of the X-ray tube. This wedge is then rotated 360° around the central axis of the receiving opening 29. However, for practical reasons, the region around the tip of the wedge (i.e., the apex region) is also not accessible for the holding device, since the wafer 10 still has to be inserted and clamped here (see FIG. 7B).

The axial clamp 2 presses with its free end onto the edge of the wafer 10, which has no structure to be inspected. For manufacturing-related reasons, wafers 10 have an unused edge region—generally, there are no structures to be inspected in the outer 3 mm of the wafers 10 (so-called edge exclusion)—; in this region, the axial clip 2 presses on the wafer 10. The free end of the axial clip 2 is made of a plastic, preferably a conductive PEEK (to avoid electrostatic charging).

As already explained in FIG. 3, with regard to the materials used that come into contact with the wafer 10, care must be taken that it not damage the wafer 10—in particular scratch it—so they should be softer than the wafer 10. Moreover, the formation of particles due to abrasion should be avoided. However, the materials used must also ensure that when clamped, there is no movement of the wafer 10 relative to the holding device. There should also be no electrostatic charging. The material must also be hard enough to be clamped with a precisely defined force so that the material does not flow, as is the case with elastomers. In addition, the material must be permanently resistant to X-rays to ensure long-term use.

In the four parts of FIG. 8, the process of clamping the wafer 10 on the holding device is shown in four phases, with the first, fully opened state according to FIG. 8A being present after the wafer 10 has been fixed by the radial clamps 1 in its radial position and with respect to its angular orientation. The region shown in FIG. 7A is always shown in all four parts.

In FIG. 8A, the axial clamp 2 is shown in its open position R1, in which its free end is in a radially retracted position, whereby the wafer 10 can be inserted into the holding device with greater play, which is illustrated by the two vertical dotted lines whose distance from each other defines the free space 25.

The axial clamp 2 is then moved from its position shown in FIG. 8A to its position shown in FIG. 8B due to the mechanism actuated by the axial control element 15. The axial clamp 2 is moved predominantly in the radial direction, so that it maintains its vertical distance A1 from the wafer 10. The (slight) movement of the cam ring 6 precisely determines the angular orientation of the wafer 10. A radial distance R2 from the center of the wafer 10 is then achieved, which is closer to it than was the case in the open position R1 of FIG. 8A. The radial distance R2 is such that the edge of the wafer 10 is located vertically below the free end of the axial clamp 2. The unchanged vertical distance A1 means that wafers 10 can also be clamped that are warped and whose edges are not in a (horizontal) plane.

Thereafter, the axial clamp 2 is moved from its position shown in FIG. 8B to its position shown in FIG. 8C due to the mechanism actuated by the axial control element 15. The axial clamp 2 is moved predominantly in the vertical direction, so that it reduces its vertical distance A1 from the wafer 10. In the intermediate position shown, the free end of the axial clamp 2 is located in the immediate vicinity above the edge of the wafer 10.

In order to move the axial clamp 2 from the intermediate position shown in FIG. 8C to the clamping position A2 shown in FIG. 8D, the free end of the axial clamp 2 is moved downward by a spring. The free end of the axial clamp 2 then presses resiliently onto the edge of the wafer 10 and thereby compensates for any possible distortion of the wafer 10.

In summary, it can be said that the holding device according to the disclosed embodiments enables easy loading of the wafer 10 to be inspected and then enables secure clamping of the wafer 10 during the inspection. In this case, a very high magnification can be achieved during the implementation of an X-ray laminography process, since the holding device is very low in the region in which the X-ray tube 21 has to be moved close to the wafer 10 and, in addition, due to the pointed design of the clips 3 and the radial clamps 1 and the axial clamps 2, no interfering material is present in the beam path when the detector 24 is arranged at large angles, such as 60°. Furthermore, the entire region of the wafer 10 to be inspected can be inspected, since it is only touched by the radial clamps 1 and the axial clamps 2 in its unused edge region (for example, if edge exclusion is present, the edge region is not occupied by structures to be inspected) and the wafer 10 also rests on the support surface 17 only in the unused edge region. The height in the region of the support surface 17 and the clips 3 is so small that the X-ray tube 21 with its focus can be moved very close to the wafer 10, which results in very high magnification. Even warped wafers 10 can be securely clamped into the holding device.

In the three parts of FIG. 9, the process of clamping the wafer 10 to the holding device is shown in three phases. The states at a radial clamp 1 in the lowest level and the states at an axial clamp 2 in the level above that are shown in FIGS. 9A and 9B. The two drawing planes have been arranged one above the other solely for the sake of clarity; the two clamps 1, 2 are actually located in the same plane, just at different positions on the edge of the wafer 10. In FIG. 9C, the radial clamp 1 is not shown because its condition and position are no longer important, given that the wafer 10 is clamped here by the axial clamps 2. Unlike the exemplary embodiment depicted in FIG. 8, here the X-ray tube 21 is arranged above the wafer 10.

FIG. 9A shows the open state after the wafer 10 has been placed on the support surfaces 17 on the axial clamps 2 by an insertion device—for example of a robot arm, or of an operator. Another difference from the exemplary embodiment according to FIG. 8 is that the axial clamps 2 have two movable parts, a support element 31, and a clamping element 32, the movement of each of which is controlled by a separate axial control element 15 (not shown).

In FIG. 9A, the X-ray tube 21 is retracted upward so that the wafer 10 can be inserted. The support element 31 is in its lower position and is mounted on the axial clamp 2 so as to be rotatable about a horizontal rotation axis 33. The clamping element 32 is in its radially retracted position; the same applies to the axial clamp 1, which is also in its radially retracted position—its radial positioning surface 34 and the inner tip of the clamping element 32 are at the same radial distance from the center of the receiving opening 29 formed by the support surfaces 17 and shown, for example, in FIG. 3 for another exemplary embodiment (shown by the right vertical dashed line; however, the left vertical dashed line shows the edge of the wafer 10). This also provides more clearance in the radial direction during the insertion of the wafer 10 - corresponding to twice the distance between the two vertical dashed lines.

In FIG. 9B, the X-ray tube is still in its retracted position, as in FIG. 9A, and the position of the support element 31 is unchanged compared to FIG. 9A. However, the clamping element 32 has moved inward in the radial direction. The same applies to the radial clamp 1. It has moved so far inward in the radial position that its radial positioning surface 34 strikes the edge of the wafer 10 and, in cooperation with the two other radial clamps 1, which are not shown—comparable to the illustrations in FIGS. 1, 2, and 3 of the other exemplary embodiment—the correct alignment (centering and angular alignment) of the wafer 10 on the holding device takes place. The radial position of the radial clamp 1 (with its radial positioning surface 34) from the center of the receiving opening 29 is the same as the radial position of the tip of the clamping element 32 of the axial clamp 2.

In order to move from the representation in FIG. 9B to that in FIG. 9C, the support element 31 together with the wafer 10 positioned thereon by the axial clamps 1 has been moved upward in the axial direction. This movement occurs about the rotation axis 33 until the edge of the wafer 10 is clamped between the support element 31 and the clamping element 32, whose position has not changed. In this clamped state of the wafer 10, it can no longer move from its position, so that the radial clamps 1 required for centering the wafer 10 can be retracted again in order to avoid damaging the wafer 10. The X-ray tube 21 has been lowered to be as close as possible to the wafer 10 so that the magnification during the inspection is as high as possible. The support element 31 performs the clamping action against a spring, which on the one hand prevents the pressure on the wafer 10 from becoming too great and on the other hand, in the event of an unintentional contact of the wafer 10 by the X-ray tube 21 in the axial direction, the wafer 10 can deflect axially downward against the spring pressure. Both serve to prevent damage to or destruction of the wafer 10.

### LIST OF REFERENCE SYMBOLS

1 radial clamp
2 axial clamp
3 clip
4 base body
5 proximity sensor
6 cam ring
7 nose
8 load compensator
9 manipulator
10 wafer
11 first stop
12 second stop
13 control contour
14 radial control element
15 axial control element
16 compensator control element
17 support surface
18 stop edge
19 control lever
20 cam ring drive
21 X-ray tube
22 central beam at 0°
23 central beam at 60°
24 detector
25 free space
26 drive lever
27a first bearing stop element
27b second bearing stop element
28 cam ring bearing
29 receiving opening
30 clamp body
31 support element
32 clamping element
33 axis of rotation
34 radial positioning surface
A1 vertical distance
A2 clamping position
R1 open position
R2 radial distance

1. A holding device for a disc-shaped component as part of a manipulator of an X-ray inspection system, wherein the holding device comprises an X-ray tube and a detector in which a position and orientation of the component is configured be corrected by radial clamps, each of the radial clamps exerting a force in a direction of the center of the component in a plane thereof, in which access to the component is enabled for the X-ray tube on one side of the component and allows for a free space on the other side of the component for a beam cone of the X-ray tube.

2. A holding device for a disc-shaped component as part of a manipulator of an X-ray inspection system, the holding device comprising:
a support surface formed in one plane;
a base body on which the support surface is located, and with a cam ring which can be rotated thereto;
at least three radial clamps, each of which is linearly movable between an open position and a locked position by a first displacement device, each of which is linearly movable in the radial direction relative to the support surface by a radial control element;
at least two axial clamps, each of which is movable between an open position and a clamping position by a second displacement device, which is movable in the radial and axial direction relative to the support surface by an axial control element; and
a connecting device for connecting the holding device to the manipulator;
wherein the cam ring has a control contour that defines movement of the radial control elements and the axial control elements, the radial clamps and the axial clamps being securely connected to the base body.

3. The holding device according to claim 2, wherein the support surface extends at least partially along a circular ring with a stop edge extending at least partially along a cylinder lateral surface, which stop edge extends perpendicular to the support surface and has a diameter which is larger than a diameter of the component to be received, and the base body extends outside the cylinder lateral surface.

4. The holding device according to claim 2, wherein the support surface is formed from individual surfaces that are formed on U-shaped clips in a region of a connecting bar of the U and free ends of parallel bars of the U are securely connected to the base body.

5. The holding device according to claim 4, wherein the radial clamps and/or the axial clamps are arranged in a free space of the clips between the parallel bars of the U.

6. The holding device according to claim 2, wherein the axial clamps each have a support element on which a support surface is formed, and each has a clamping element, which clamping elements are movable independently of one another, the clamping elements being radially movable, and the support elements are movable in a direction with an axial component about a horizontal axis of rotation.

7. The holding device according to claim 6, wherein the axial control element of the axial clamp cooperates with the support element, and the second displacement device additionally has a further axial control element that cooperates with the clamping element.

8. The holding device according to claim 2, wherein exactly three radial clamps are present, of which exactly one has a nose at its free end that has a shape of a part of a cylinder lateral surface perpendicular to the support surface.

9. The holding device according to claim 2, wherein all free ends of the radial clamps and/or of the axial clamps have a plastic end part that is detachably connected to a rest of the respective clamp.

10. The holding device according to claim 2, wherein there are exactly six axial clamps associated in pairs, and distances between adjacent pairs are equal and/or a radial clamp is arranged between the two axial clamps of a pair.

11. The holding device according to claim 2, wherein the second displacement devices of the axial clamps are each embodied as a slider-crank mechanism or as a control link.

12. The holding device according to claim 2, wherein the axial clamps are each pressed into their clamping position by a replaceable spring and/or the radial clamps are each pressed into their locked position by a replaceable spring.

13. The holding device according to claim 2, wherein at least one load compensator is arranged on the base body, which load compensator has a compensator control element that is always in contact with the control contour of the cam ring, the control contour being shaped in a vicinity of the compensator control element inversely to the control contour in a region of the radial control elements and of the axial control elements with respect to its radial distance from a stop edge of the support surface.

14. The holding device according to claim 2, wherein a first stop and a second stop are formed to be stationary on the base body, and a control lever is formed to be stationary on the cam ring, the control lever being movable between the first stop and the second stop.

15. The holding device according to claim 2, wherein a cam ring drive attached to the manipulator is partially engaged via a drive lever with a control lever on the cam ring in order to rotate the cam ring relative to the base body.

16. A method for clamping a disc-shaped component to a holding device as part of a manipulator of an X-ray inspection system, comprising:
placing the component in a pre-aligned manner on a support surface;
carrying out a radial alignment and an angular alignment of the component by radial clamps; and
fixing the component in an axial direction by axial clamps.

17. The method according to claim 16, wherein movement of the axial clamps occurs first in the radial direction and then in the axial direction.

18. The method according to claim 16, wherein first a radial movement of a clamping element and then a movement of a support element of the axial clamps with an axial component takes place until the component is fixed in the axial direction between the clamping element and the support element.

19. The method according to claim 18, wherein the radial movement of the axial clamps occurs simultaneously with the radial alignment of the component.

20. The method according to claim 16, wherein in the axial clamps and/or in the radial clamps, a maximum force acting on the component is limited by a spring force.
